(19) United States
(12) Patent Application Publication
(10) Pub. No.: US 2013/0136886 A1
(43) Pub. Date: May 30, 2013

(54) Foam Filled Composite Construction Panel with Heating and Cooling Means

(71) Applicant: Rhinokore Composites Manufacturing Partnership, Calgary (CA)

(72) Inventor: Paul J. Dagesse, Beaverlodge (CA)

(73) Assignee: RHINOKORE COMPOSITES MANUFACTURING PARTNERSHIP, Calgary (CA)

(21) Appl. No.: 13/682,105

(22) Filed: Nov. 20, 2012

Related U.S. Application Data
(60) Provisional application No. 61/563,587, filed on Nov. 24, 2011.

(51) Int. Cl. E04C 2/52; B32B 3/12; B32B 5/18

(52) U.S. Cl. CPC E04C 2/525; B32B 5/18; B32B 3/12
USPC 428/71; 428/119; 428/118

(57) ABSTRACT

A composite construction panel comprises a core having an upper surface and a lower surface, a rigid upper cover sheet positioned above the upper surface, a rigid lower cover sheet positioned below the lower surface, and at least one conduit extending through the core having first and second ends terminating at one or more side edges of the core. The core is formed from an insulating material and includes rigid supporting members extending between and generally perpendicular to the upper surface and the lower surface. The upper and lower cover sheets are bonded to the supporting members to form a rigid composite panel. At least a portion of the core is removed adjacent at least a portion of the length of the conduit such that the lower and side portions of the conduit are adjacent to, and insulated by, the insulating material, but the upper portion is not insulated.

### FIELD

This invention relates to generally to construction panels which may be used in isolation or in conjunction with like panels to form a mat-like structure, a containment tank or enclosure, etc. The invention also relates to such construction panels that are foam filled composites with heating and cooling means.

### BACKGROUND

There are numerous applications in the construction industry where it is desirable to utilize equipment mats, holding or containment tanks and other such structures on a somewhat temporary or semi-permanent basis. For example, in the oil and gas industry it is often desirable to position drilling equipment upon a large mat-like structure in order to provide a relatively solid base and to help distribute the weight or load of the equipment over a larger area. It is also often desirable to construct temporary containment tanks into which slurries and/or liquids can be pumped and stored until such time as they can be further processed or otherwise collected and shipped to other locations. In the case of a drilling rig, drilling mud typically contains toxic and/or expensive additives that either cannot be released into the environment or that for economic reasons need to be recovered. In such instances, as the drilling mud leaves the casing it is directed into a rig tank, after which it can be recycled back into the drilling circuit or gathered and shipped for processing, disposal or reuse.

Since in many cases structures such as those described above are required on a temporary basis, it has been suggested that they can be formed from construction panels made from foam filled composites that have significant strength-to-weight ratios, making them attractive in terms of shipping costs and ease of assembly at a construction site. U.S. patent application Ser. No. 12/355,827 describes an example of one such construction panel.

While existing composite construction panels present an effective means to create mats, containment tanks and other structures, when used in high or low temperature environments they present only a limited ability to protect the equipment that may be placed on them, the ground surface over which they are installed or, in the case of a tank, the fluids or liquids retained therein, from the effects of excess ambient temperatures. For example, in northern climates drilling operations are often conducted in the winter when the ground and surrounding terrain is sufficiently frozen to support trucks and heavy machinery. During winter drilling operations care must be taken to ensure that water within drilling mud retained in a rig tank is not allowed to freeze. In some instances it may be necessary to insert immersion heaters into the rig tanks to prevent them from freezing, a process that can be labour intensive, expensive and that results in the heater being exposed to contaminants and toxic materials found within the drilling mud.

There is a continuing need to develop structures and methods to help maintain the temperature of equipment, the surface over which equipment is installed, and/or liquids or materials held in retention tanks in an effective, cost efficient and less labour intensive manner.

### SUMMARY

The invention therefore provides a new and improved composite construction panel that addresses some of the limitations in currently available panels.

In one of its aspects the invention provides a composite construction panel comprising a core having an upper surface and a lower surface, said core formed from an insulating material and including a plurality of rigid supporting members extending between and generally perpendicular to said upper surface and said lower surface; a rigid upper cover sheet positioned above said upper surface of said core, and a rigid lower cover sheet positioned below said lower surface of said cover, said cover sheets bonded to said supporting members to thereby form a rigid composite panel; and, at least one conduit having first and second ends terminating at one or more side edges of said core, said conduit extending through said core, wherein at least a portion of said core is removed adjacent at least a portion of the length of said conduit such that the lower and side portions of said conduit are adjacent to, and insulated by, said insulating material and the upper portion of said conduit is not insulated by said insulating material.

Further aspects of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is an upper perspective view of a tank or containment vessel, shown in partial schematic form, manufactured through the use of constructions panels formed in accordance with one of the embodiments of the invention;

FIG. 2 is an upper detailed perspective view of section “A” of FIG. 1;

FIG. 3 is a plan view of the tank or containment vessel shown in FIG. 1;

FIG. 4 is a side elevational view of the tank or containment vessel shown in FIG. 1;

FIG. 5 is an upper perspective schematic view of a construction panel formed in accordance with one embodiment of the invention;

FIG. 6 is an enlarged detailed view of portion “A” of FIG. 5;

FIG. 7 is a side elevational view of the detailed view shown in FIG. 6;

FIG. 8 is a vertical sectional view taken along the line 8-8 of FIG. 5; and,

FIG. 9 is a partial plan view of an embodiment of the core of the construction panel made in accordance with the present invention.

### DESCRIPTION

The present invention may be embodied in a number of different forms. However, the specification and drawings that follow describe and disclose only some of the specific forms of the invention and are not intended to limit the scope of the invention as defined in the claims that follow herein.

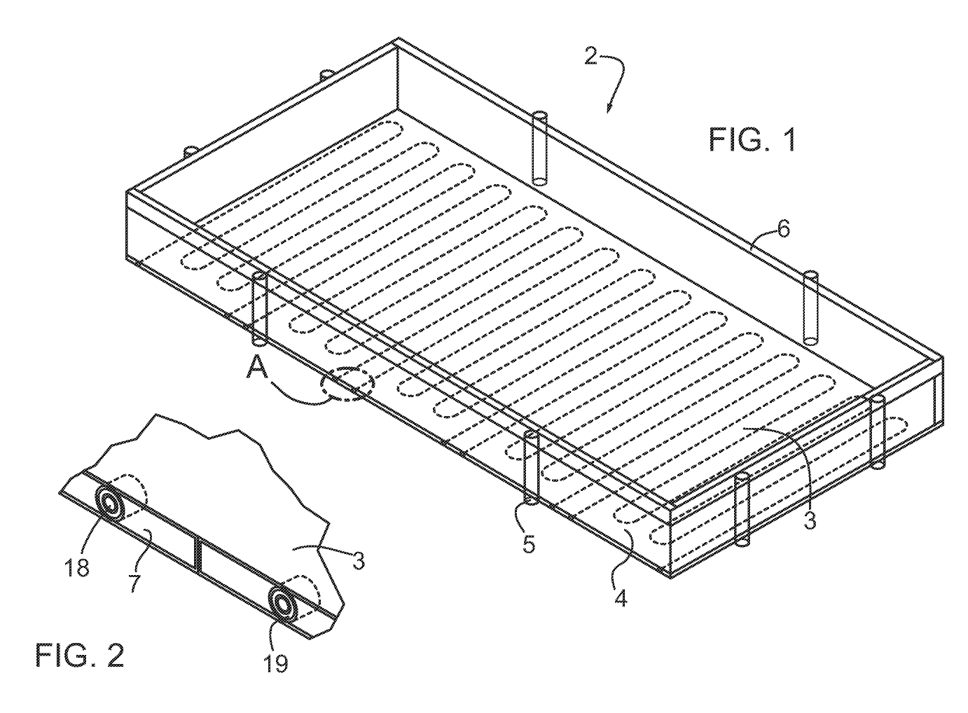

In the attached Figures there is shown a composite construction panel 1 formed in accordance with one of the exemplary embodiments of the present invention. In the case of FIG. 1, a plurality of such panels have been assembled together to form the base or the bottom structure of a tank or containment vessel 2. In the embodiment shown in FIG. 1, containment vessel 2 is comprised generally of a base 3, wall members 4, structural supports 5, and a liner 6.

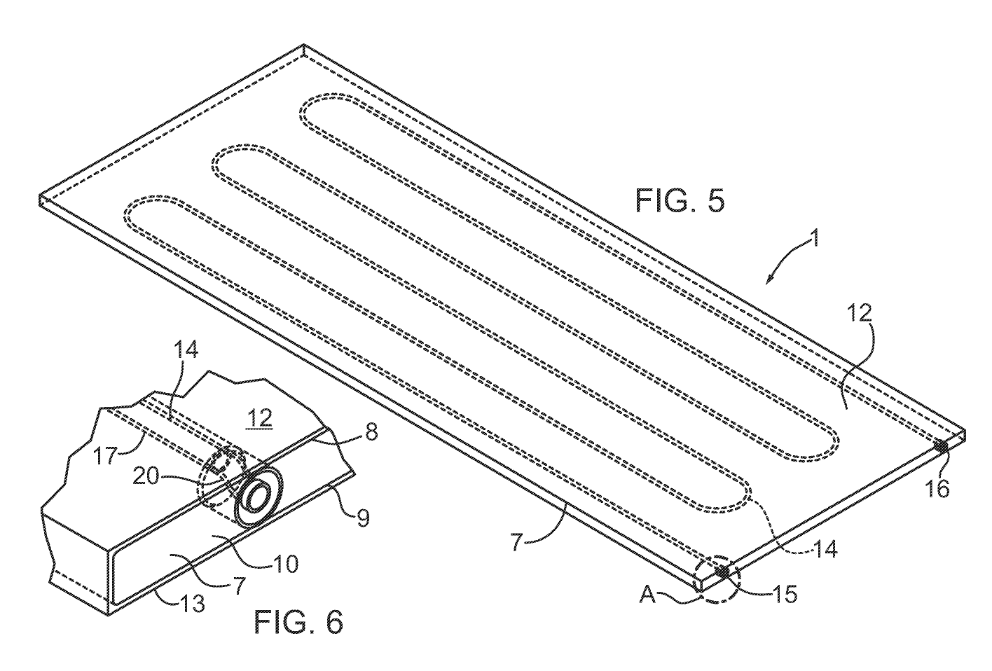

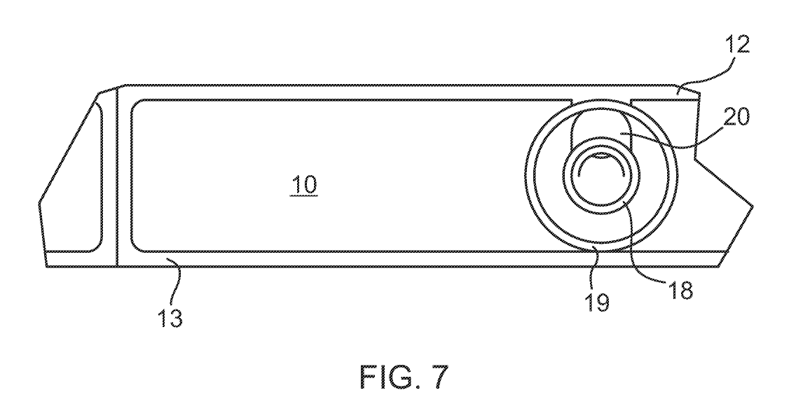

Referring to FIGS. 5 through 9, construction panel 1 is comprised generally of a core 7 that has an upper surface 8 and lower surface 9 that are generally parallel to one another. The core is formed from an insulating material 10 that, as will be appreciated from a thorough understanding of the invention, could be any one of a wide variety of insulating materials including a rigid foam such as a polyurethane foam. In other embodiments, insulating material 10 could be in the form of a semi-rigid foam (for example latex), or could include other types of more traditional insulating materials such as rock wool or fibreglass.

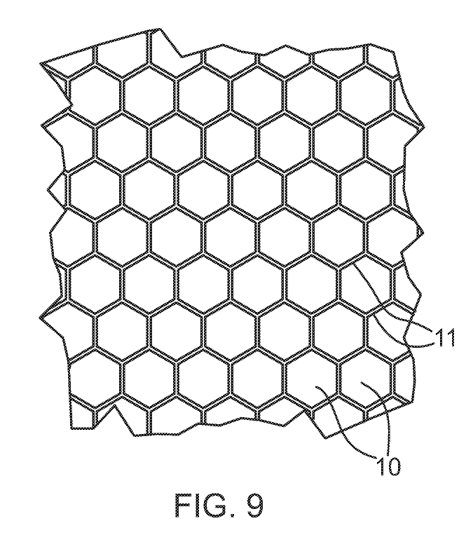

Core 7 further includes a plurality of rigid supporting members 11 that extend generally perpendicular between upper surface 8 and lower surface 9. Rigid upper and lower cover sheets 12 and 13 respectively, are positioned immediately adjacent the upper and lower surfaces of the core and are bonded to the respective upper and lower portions or ends of supporting members 11 thereby form a rigid composite panel. Preferably cover sheets 12 and 13 encase core 7 making it fluid impermeable so that water or other fluids that come into contact with the exterior portions of the cover sheets are prevented from seeping into the interior of core 7. Supporting members 11 and upper and lower cover sheets 12 and 13 will most typically be formed from a relatively high strength, low weight, polymer or synthetic material, such as fibreglass, carbon fibre, polycarbonate, Kevlar™, high strength plastics, or combinations thereof. In some applications the cover sheets and/or supporting members may be metal, such as aluminum. Further, supporting members 11 may be generally tubular cells extending between the upper and lower cover sheets. Both the interior of the cells and the voids between adjacent cells are comprised of insulating material 10. In one particular embodiment, supporting members 11 are hexagonal tubular cells that are joined together to form a generally honeycomb array (see FIG. 9). In an alternate embodiment of the invention supporting members 11 may comprise the side surfaces of core 7 such that the supporting members and the upper and lower cover sheets together form a rigid box-like structure whose interior is filled with insulating material 10.

In accordance with the invention, construction panel 1 further includes at least one conduit 14 having first and second ends, 15 and 16 respectively, terminating at one or more side edges of core 7. Conduit 14 extends through core 7. In most instances it is expected that the conduit will generally loop back and forth across panel l(for example, as shown in FIG. 5). In an alternate embodiment the conduit could run directly from one edge of the core to another edge in a straight path.

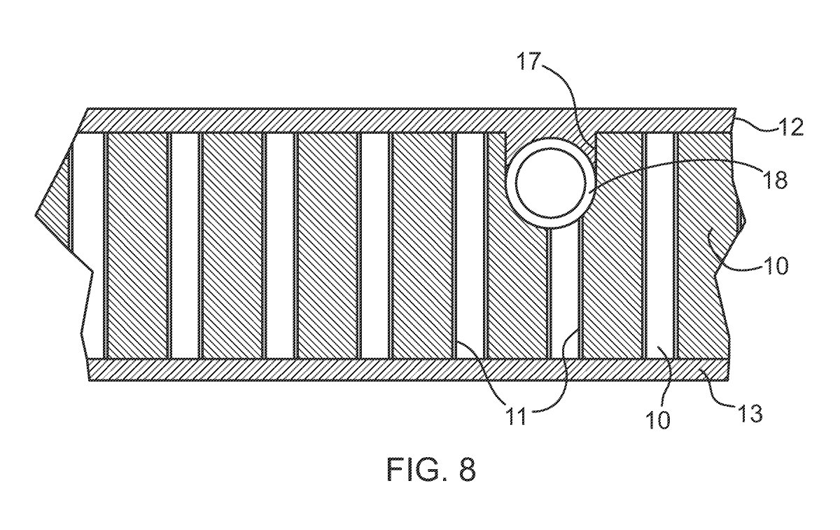

To accommodate conduit 14, at least a portion of core 7 is removed adjacent to at least portion of the length of the conduit in a manner that permits the conduit to extend across the core such that the lower and side portions or quadrants of the conduit are adjacent to, and insulated by, insulating material 10. That is, the sides and the bottom portion of the conduit lie against insulating material 10, whereas the top portion or upper quadrant of the conduit is not in contact, and is not insulated by, insulating material 10 (see, for example, FIG. 8). In the embodiment of the invention shown in the attached drawings, the upper portion of the conduit is covered by upper cover sheet 12. Where the upper cover sheet covers the upper surface of the conduit, the conduit will be held securely in place within core 7 and will generally be protected from abrasion or puncturing through operation of the upper cover sheet. Where the upper and lower covers sheets are formed through an extrusion coating process, the extrusion material forming the upper cover sheet may be allowed to flow downwardly over the surface of conduit 14 and harden in place. In other instances, where the cover sheet is secured to the support members through the use of resins, adhesives or other forms of chemical bonding, the resin, adhesive or other bonding material may equally be allowed to flow downwardly over the upper surface of the conduit and allowed to harden or cure in place.

While it will be appreciated that in the attached drawings the upper cover sheet encompasses conduit 14, in an alternate embodiment of the invention the upper cover sheet adjacent to the upper portion of the conduit may be removed or may be absent, such that the upper surface or upper portion of the conduit is exposed. In either instance, (and as shown in FIG. 8), in a preferred embodiment of the invention the upper-most portion of conduit 14 is at substantially the same elevation as the upper cover sheet along a substantial length of conduit 14. That is, as shown in FIG. 8, the majority of conduit 14 is not positioned centrally (nor toward the bottom) within core 7, but rather is positioned at or near the top of the core.

From a thorough understanding of the above, it will be appreciated that conduit 14 essentially lies within a channel 17 positioned within core 7 of construction panel 1. Channel 17 could be formed during the manufacturing of the core or, alternatively, could be later cut into the core in a desired pattern through the use of a router, die cutter, thermal cutter or other such means.

With references to FIGS. 2, 6 and 7, there is shown an exemplary structure that provides a means by which a first and second ends of conduit 14 may be connected to the conduit or conduits of an adjacent panel, or to a supply of heated or chilled fluid. In this embodiment of the invention first and second ends 15 and 16 of conduit 14 include coupling members 18. As described above, in one of the preferred embodiments of the invention conduit 14 is situated generally in the upper or top portion of core 7. With the upper surface of conduit 14 at or near the upper surface of panel 1, to accommodate the increased diameter of coupling member 18, and also to help facilitate the connection of the coupling member to the conduit of like panels or to a supply of heated or chilled fluid, in the embodiment shown in the attached drawings conduit 14 is off-set in a downward direction next to the exterior edge of the construction panel with coupling member 18 positioned generally toward the middle of the panel. A hollow sleeve 19, having a diameter larger than conduit 14 and coupling member 18, is inserted into core 7 about the conduit and the coupling member.

In one embodiment of the invention conduit 14 is polyethylene or a similar relatively flexible material that permits its ends to be off-set downwardly at the point that they exit the side surface of panel 1 as described above. In an alternate embodiment, a dedicated off-set fitting 20 may be utilized that is connected to the end of conduit 14 and that extends approximately to the edge of the side surface of construction panel 1 where it is engaged by coupling member 18. Off-set fitting 20 could be rigid, semi-rigid or flexible. In still a further embodiment, off-set fitting 20 and coupling member 18 may be in the form of a unitary fitting. In any case, it will be appreciated that the increased diameter of sleeved 19 allows coupling 18 and/or off-set fitting 20 and/or the end of conduit 14 to be moved within the confines of the increased diameter of the sleeve to help facilitate connection to an adjacent panel or a supply of heated or chilled fluid. It will also be appreciate that the increased diameter of sleeve 19 allows the junction between coupling member 18 and an adjacent panel or fluid supply to be inherently flexible, and to thereby accommodate potential settling or movement between adjacent panels that could otherwise cause damage to the piping connection and potentially result in leaks.

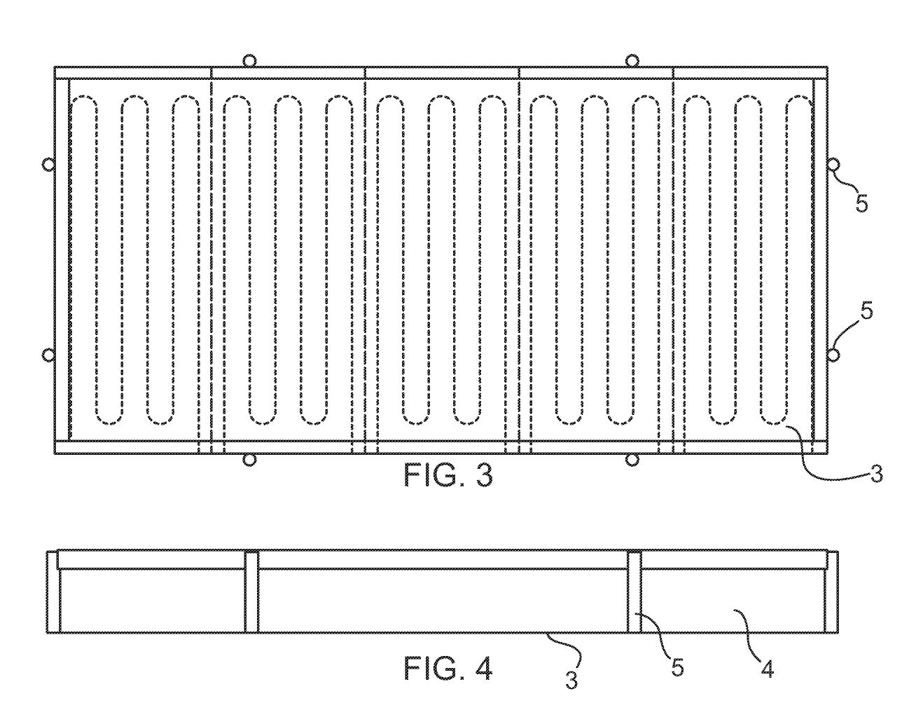

It will thus be understood from a thorough understanding of the structure described above and shown in the attached drawings that there is described a composite construction panel that is both strong, lightweight and that presents an ability to heat or cool material or surfaces that are adjacent to its upper surface. Depending upon the application, panel 1 can be constructed in a fashion that positions conduits 14 with their ends situated such that the conduit in one panel can be fluidly connected to the conduit in an adjacent panel such that fluid pumped through the conduits is allowed to flow between respective panels. Alternately, both ends of a conduit could terminate along a common side of a panel (for example see FIGS. 3 and 5). The respective ends of the conduit could then be connected directly to a supply of pressurized fluid or, alternately, together with a series of adjacent panels, connected to a header or manifold that delivers fluid to each of the respective panels. Heated or chilled fluid pumped through conduits 14 will thus tend to heat or cool the upper exterior surface of the panel.

The positioning of conduit 14 in the upper portion of the core 7 of panel 1 helps to direct the heating or cooling effect of pumping fluid through the conduit toward the upper surface of the panel. Such a structure, in combination with the effects of surrounding the conduit on three sides with insulating material 10, increases the efficiency of the heating and cooling system and helps to ensure that more of the desired heating and cooling effect is directed toward the desired surface of panel 1. For example, in the instance where the panels are used to form a tank or containment vessel to be placed on frozen ground, heated fluid can be pumped through conduits 14 in order to maintain the temperature of the contents of the vessel at a desired level, while at the same time insulating the frozen ground below from both the effects of the heated fluid that passes through the conduit and the heated contents of the vessel. It will also be appreciated that in particular instances it may be desirable of flip the panels upside down such that heated or cooled fluid pumped through conduit 14 is directed to the surface upon which the panels are placed (for example chilled fluid could be pumped through the conduits in order to help maintain the ground over which the panels are placed in a frozen state when the contents of the tank or containment vessel are at an elevated temperature). To assist in transmitting heating or cooling from fluid pumped through conduit 14, in some applications upper cover sheet 12 may include metallic additives to enhance its thermal conductivity.

It is to be understood that what has been described are the preferred embodiments of the invention and that it may be possible to make variations to these embodiments while staying within the broad scope of the invention. Some of these variations have been discussed while others will be readily apparent to those skilled in the art.

I claim:

1. A composite construction panel comprising:
a core having an upper surface and a lower surface, said core formed from an insulating material and including a plurality of rigid supporting members extending between and generally perpendicular to said upper surface and said lower surface;
a rigid upper cover sheet positioned above said upper surface of said core, and a rigid lower cover sheet positioned below said lower surface of said core, said upper and lower cover sheets bonded to said supporting members to thereby form a rigid composite panel; and,
at least one conduit having first and second ends terminating at one or more side edges of said core, said conduit extending through said core,
wherein at least a portion of said core is removed adjacent at least a portion of the length of said conduit such that a lower portion and side portions of said conduit are adjacent to, and insulated by, said insulating material and an upper portion of said conduit is not insulated by said insulating material.

2. The panel as claimed in claim 1 wherein at least a portion of said upper cover sheet adjacent said upper portion of said conduit is removed and the upper portion of said conduit is exposed.

3. The panel as claimed in claim 1 wherein said upper portion of said conduit is covered by said upper cover sheet.

4. The panel as claimed in claim 3 wherein said supporting members comprise side surfaces of said core, said upper and lower cover sheets and said side surfaces forming a rigid box-like structure.

5. The panel as claimed in claim 3 wherein said supporting members are generally tubular cells.

6. The panel as claimed in claim 5 wherein said insulating material is a rigid foam.

7. The panel as claimed in claim 6 wherein said foam is a polyurethane foam.

8. The panel as claimed in claim 3 wherein said supporting members are hexagonal tubular cells, extending between said upper and lower cover sheets, joined together to form a generally honeycomb array.

9. The panel as claimed in claim 3 wherein said first and said second ends of said conduit include coupling members to permit the conduit of a first panel to be fluidly connected to the conduit of a second panel when the first and second panels are adjacent one another.

10. The panel as claimed in claim 3 wherein said first and second ends of said conduit include coupling members to permit said conduit to be fluidly connected to a supply of heated or chilled fluid for pumping through said conduit to heat or cool material or objects adjacent to said upper cover sheet.

11. The panel as claimed in claim 3 wherein said upper cover sheet includes metallic additives to enhance its thermal conductivity.

12. The panel as claimed in claim 1 wherein an upper-most portion of said conduit is at substantially the same elevation as said upper cover sheet.

13. The panel as claimed in claim 1 wherein said conduit is formed from polyethylene.

14. The panel as claimed in claim 1 wherein said supporting members and said upper and lower cover sheets are fibreglass, carbon fibre, polycarbonate, Kevlar, or combinations thereof.
